(19) United States
(12) Patent Application Publication
(10) Pub. No.: US 2010/0282738 A1
(43) Pub. Date: Nov. 11, 2010

(54) COOKING APPLIANCE, IN PARTICULAR A HOUSEHOLD COOKING APPLIANCE

(75) Inventors: Jurgen Leikam, Hilpoltstein (DE); Alwin Neukamm, Wilhermsdorf (DE)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventerm (BE)

(21) Appl. No.: 12/376,605

(22) PCT Filed: Jul. 24, 2007
(86) PCT No.: PCT/EP07/06554

§ 371 Date: Jul. 6, 2010

(30) Foreign Application Priority Data
Aug. 19, 2006 (DE) 10 2006 039 087.3

(51) Int. Cl. H05B 6/12

(52) U.S. Cl. 219/624

(57) ABSTRACT

This invention relates to a cooking appliance (1), in particular to a household cooking appliance, encompassing a base unit (2) that is mounted on a wall (3) or on a countertop (4), as well as a stove top (5) that can be tilted relative to the base unit (2). For a space-saving implementation of the stove top and to achieve highly efficient food-heating performance, the invention provides for a stove top (5) with at least one induction coil (6) while the electric power supply (14) is housed in the base unit (2).

This invention relates to a cooking appliance, in particular a household cooking appliance, encompassing a base unit that is attached to a wall and/or a work surface, as well as a hinged stove top that is tiltable relative to the base unit.

Household cooking appliances according to this concept already exist. For space-saving compactness the cooking appliance consists of a base unit and, tiltable relative to the base unit, a stove top—also known as a cooking platform—that can be tilted into an upright position. In that position the cooking appliance takes up little space, constituting an essentially space saving system.

Since in general there is always a need for plenty of available countertop space in a kitchen, this configuration makes for economical utilization of the available space especially in small kitchens, a solution of significance especially in view of the trend toward single or two-person households. Another preferred target are kitchenettes often found in vacation homes or weekend cottages.

A drawback remains in the fact that even when tilted up the cooking appliance still occupies a certain amount of space.

It is therefore the objective of this invention to introduce enhancements to a cooking appliance of the type first above mentioned whereby a further improved i.e. more economical utilization of the available kitchen space is made possible. This is to be accomplished without in any way compromising the full-range functionality of the cooking appliance, its purpose being a further optimized space utilization for the cooking appliance.

The solution by which the invention achieves this objective is characterized by providing the stove top with at least one induction coil for heating the food to be cooked, as well as an electric power supply, housed in the base unit, for feeding to the minimum of one induction coil a time-variable, electric current especially of a high frequency (for generating the induction field around the induction coil). Preferably, the stove top is heated by induction coils only.

This design concept makes further space savings possible. The induction coils, employed in accordance with the invention, can be installed in the stove top in such fashion that the latter can be kept very slim. It follows that in its collapsed state the cooking appliance takes up even less space, thus leaving more space for other kitchen activities.

The stove top typically comprises one or several hotplates for food containers such as pots, pans, skillets etc., with one, several or all of these hotplates each heated by at least one induction coil.

In an enhanced design the stove top including the minimum of one induction coil is in the form of a flat plate. Preferably, this plate-shaped stove top is essentially rectangular. The advantage of a plate-shaped stove top is its essentially uniform thickness.

The axis of the hinge between the base unit and the stove top will usually extend horizontally, allowing the stove top to be tilted vertically into an upright position.

The cooking appliance may additionally be equipped with an exhaust vent. In a first design version the exhaust vent has a flat, rectangular basic outline. The exhaust vent may be connected to the base unit and/or extend vertically.

In an alternative configuration the exhaust vent is positioned above the base unit. Advantageously in that case, the exhaust vent would be a dome-shaped exhaust hood.

In all cases it has been found desirable to provide the base unit with mounting provisions for attaching it to a wall.

Means additionally provided between the base unit and the stove top can serve to attenuate the relative angular movement between the two components, thus permitting a gentle lowering of the stove top.

For safety reasons it is also possible to integrate locking and unlocking elements by means of which the stove top can be secured to and unlocked from the base unit.

Additionally, a control and/or display panel may be positioned on the far end of the stove top away from the hinge. When an exhaust hood is mounted above the base unit, the control and/or display panel may be mounted on the front of the hood.

The stove top may specifically encompass at least two induction coils, preferably of different sizes. When the stove top is tilted up, these coils may be vertically positioned one above the other. It is also possible to equip the stove top with four induction coils, arranged for instance in a matrix formation or in pairs along columns and rows.

In another design enhancement the cooking appliance is equipped with a transmitter for a virtual control panel. Such transmitters exist in prior art and are included in this context only as another advantageous feature of a cooking appliance according to the invention.

A configuration according to the invention offers various advantages which in the combination described have not been achievable before:

When the stove top is tilted up, almost all of the kitchen countertop space becomes available. In its closed, i.e. idle state, the cooking appliance thus takes up only a minimum amount of space. It incorporates all of the advantages of induction-heated hotplates over conventional hotplates. The induction-type hotplates permit a relatively thin stove top configuration since no power electronics need to be accommodated in the stove top and only the induction coils have to be integrated in the stove top.

The proposed attenuation elements permit a gentle lowering of the stove top into its working position in such fashion that any risk of an injury is minimized. A high safety level is also ensured by the locking and unlocking function designed to prevent an accidental drop-down of the stove top.

The control and display elements are positioned on the cooking appliance in an ergonomically convenient arrangement.

When installing the cooking appliance there is no need to take any enclosures, in particular lower cupboards and cabinets, into account.

The placement of the exhaust vent or hood on the cooking appliance can be optimized.

The design provides maximum support for heavy pots on the countertop.

The clearance between the countertop and the stove top, determined by the thickness of the stove top, serves as a protective thermal cushion.

The attached figures show design examples of this invention, as follows:

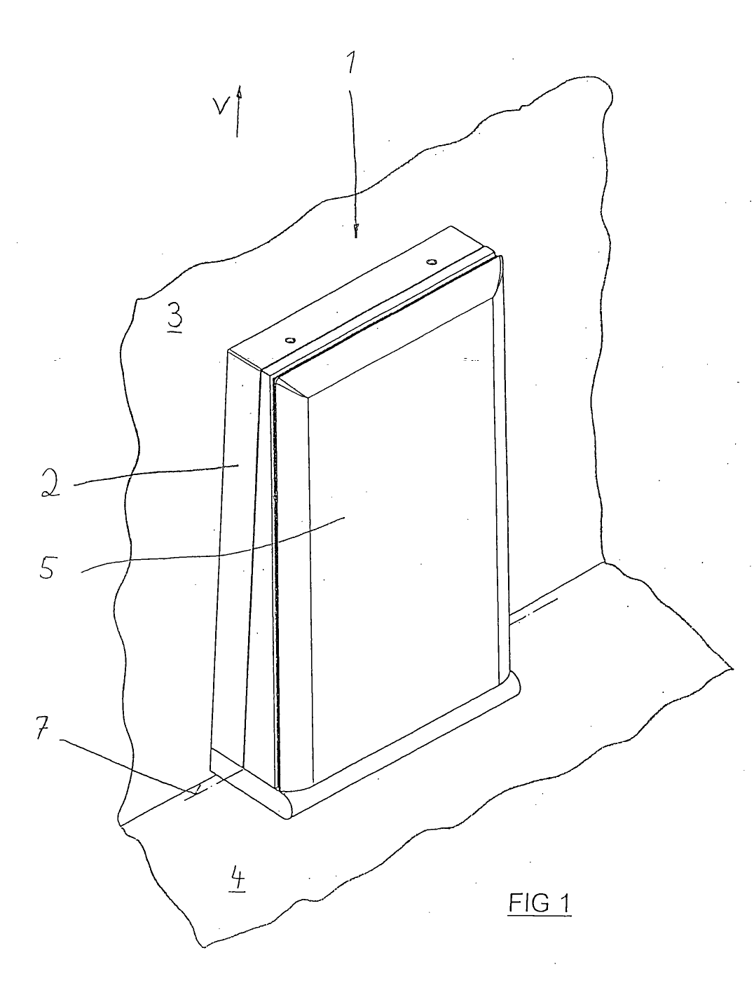

FIG. 1 is a perspective view of a cooking appliance, with the stove top of the cooking appliance tilted up into its home position;

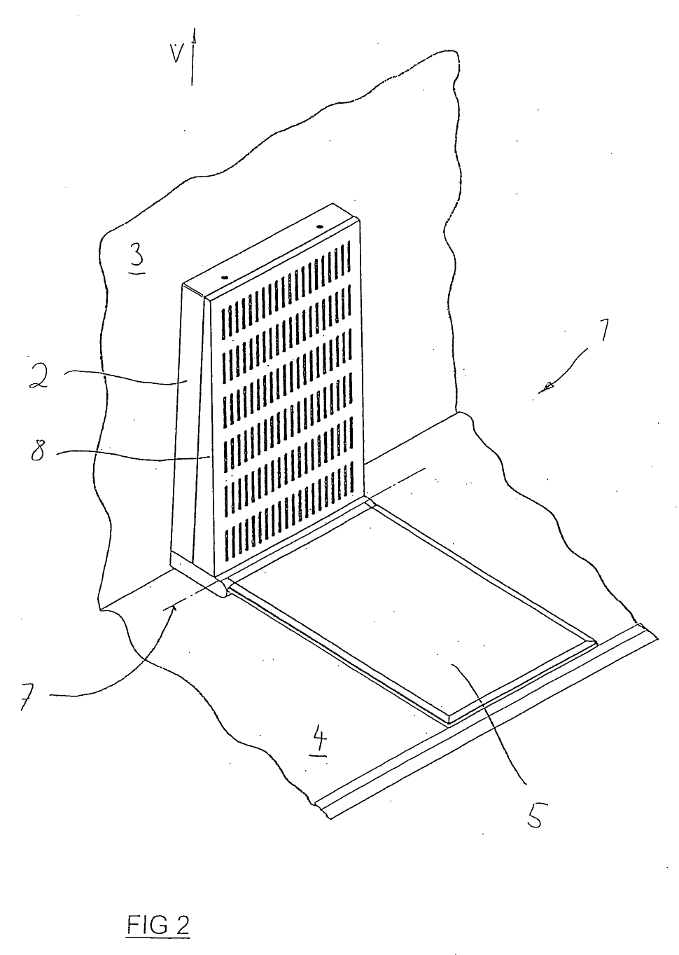

FIG. 2 shows the cooking appliance per FIG. 1 with the stove top lowered into its working position;

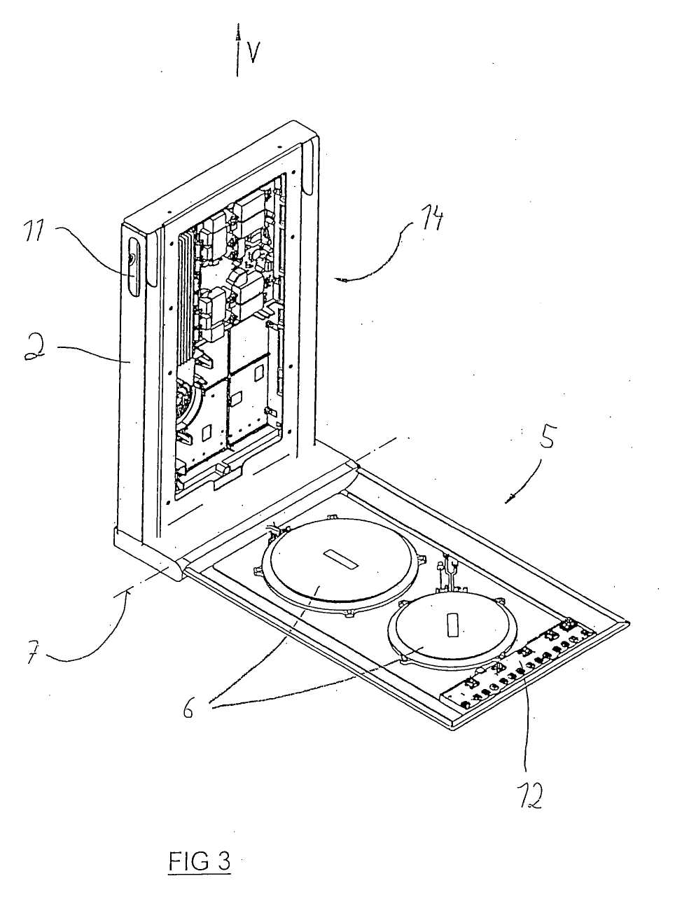

FIG. 3 shows the system per FIG. 2 with the cover panels and the exhaust vent removed to reveal the internal components of the cooking appliance;

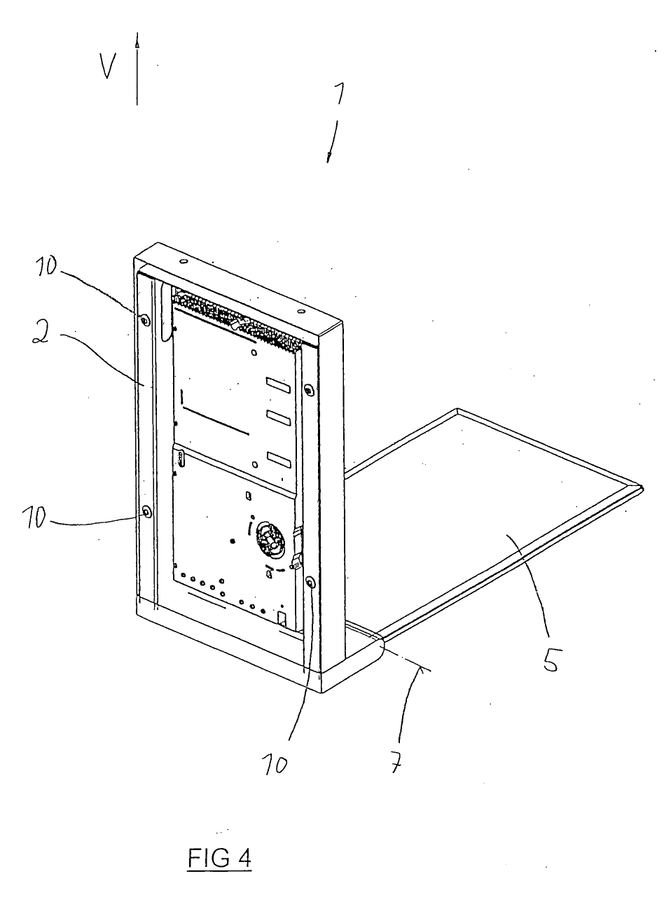

FIG. 4 is a perspective rear view of the cooking appliance, in its uninstalled state, with the stove top in its lowered position;

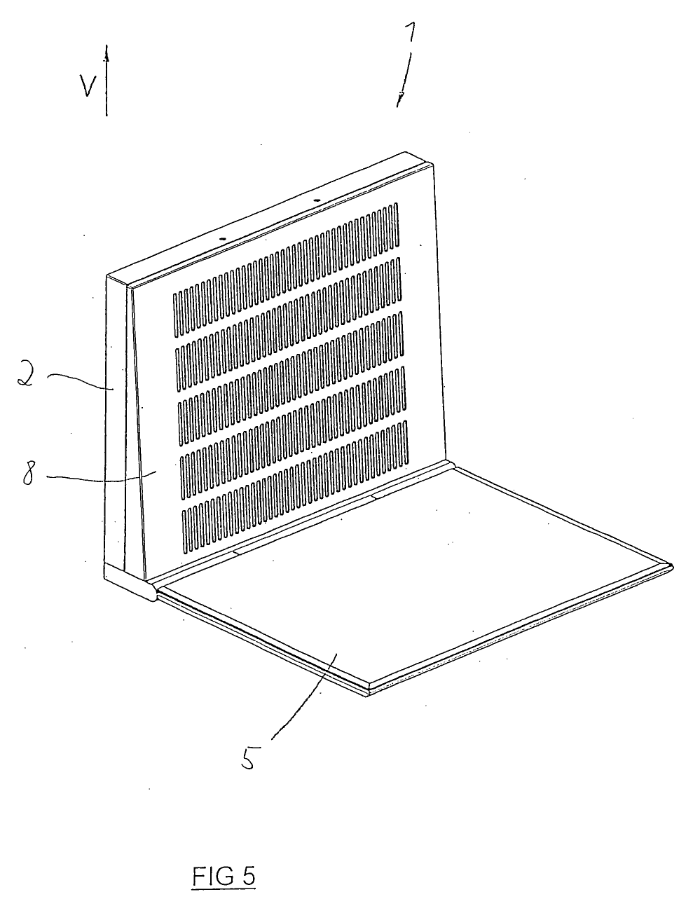

FIG. 5 depicts a cooking appliance, with several integrated hotplates, corresponding to the illustration in FIG. 2;

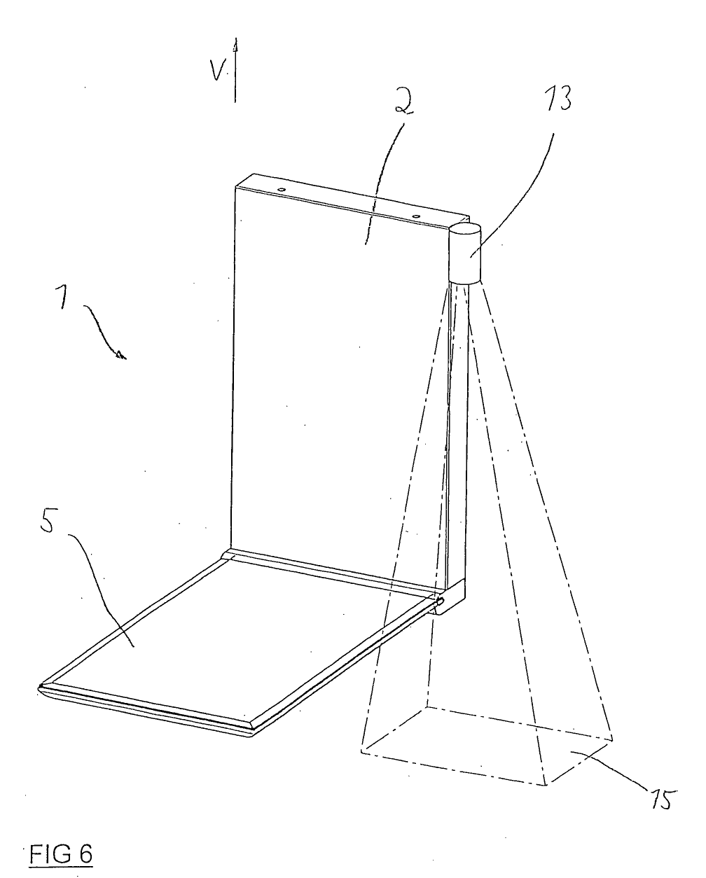

FIG. 6 shows a cooking appliance with its stove top lowered and with a transmitter for a virtual control panel;

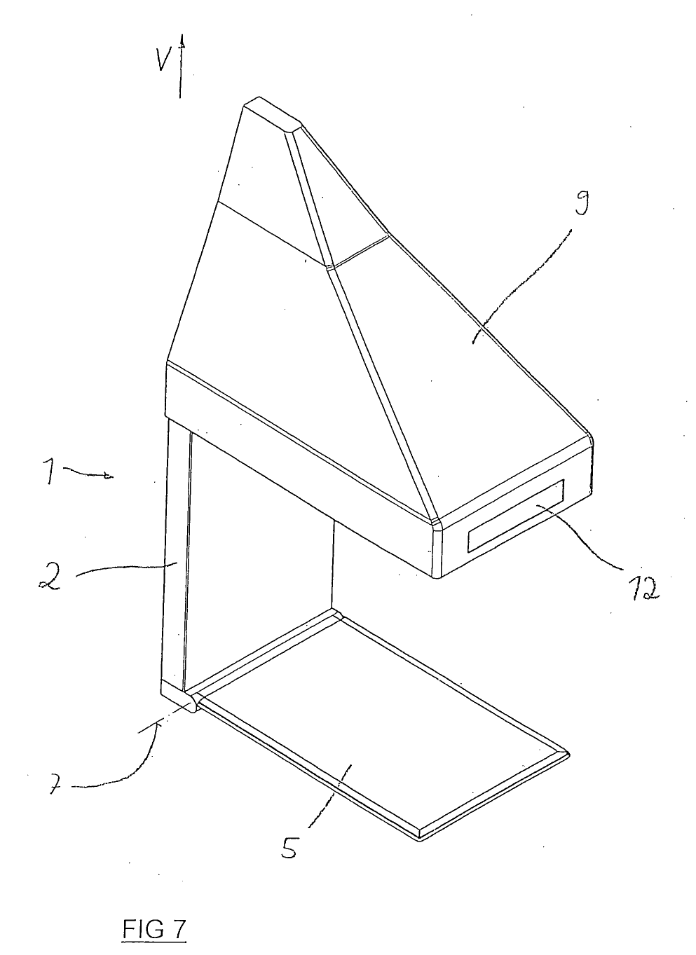

FIG. 7 illustrates a cooking appliance as in FIG. 2 with a dome-shaped exhaust hood; and

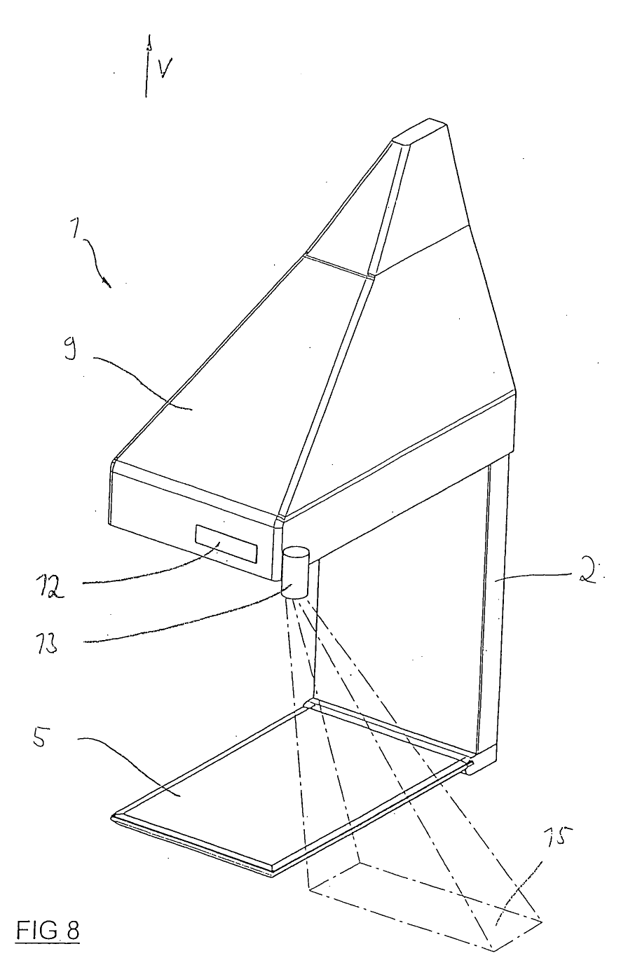

FIG. 8 shows the cooking appliance per FIG. 7 with a transmitter for a virtual control panel.

FIGS. 1 to 4 contain different views of a cooking appliance 1 in various detail. The cooking appliance 1 essentially consists of a base unit 2 and a stove top 5. The base unit 2 is firmly attached to a wall 3, that being the kitchen wall. Before being mounted on the wall 3 it is set on a countertop 4. In relation to the base unit 2 the stove top 5 can rotate around a pivot 7 that extends in a horizontal direction. The pivot is implemented in the form of a suitable hinge.

The stove top 5 can thus be in either one of two positions: When folded up as in FIG. 1, the cooking appliance 1 is in its idle or home position. At that point the essentially plate-shaped stove top 5 extends in the vertical V direction.

When the cooking appliance 1 is to be used, the stove top 5 is lowered into the position illustrated in FIG. 2 where it rests on the countertop 4, now allowing the cooking appliance 1 to be used. In this position the stove top 5 extends horizontally.

As can also be seen (in FIG. 2), an essentially plate-shaped exhaust vent 8, functioning in conventional fashion, is positioned in front of the base unit 2. It includes a filter element that may be replaced as needed. The filtered air may be vented sideways or upward.

The base unit 2 connects to electric leads, not shown and invisible when the cooking appliance 1 is installed.

FIG. 3 shows that the stove top 5 is equipped with two induction coils 6. The stove top 5 essentially contains the induction coils 6 only. The electrical system and electronics or power supply 14 for powering and regulating the induction coils 6 are housed in the base unit 2.

Located at the far end of the stove top 5 relative to the hinge 7 is a control and/or display panel 12. That panel is accessible only in the lowered position of the stove top 5. It is of a conventional design and preferably equipped with touch controls.

FIG. 3 also shows that locking and unlocking elements 11 can be provided by means of which the stove top 5 can be locked to the base unit 2. This is to ensure that the stove top 5 cannot accidentally drop down, potentially posing the risk of an injury.

As can be seen in FIG. 4, the back of the cooking appliance 1 is equipped with wall-mounting provisions 10 by means of which the cooking appliance 1 can be mounted, especially screwed, onto the wall 3 (see FIG. 1).

FIG. 5 depicts a similar design version of the cooking appliance 1. In this case the entire appliance is built wider, with the stove top 5 accommodating four hotplates preferably of different sizes. In other words, in this case the stove top 5 contains four induction coils.

FIG. 6 shows that a transmitter 13 may be provided for use with a virtual control panel 15.

The configuration shown in FIG. 7 includes a dome-shaped exhaust hood 9 that is mounted above the cooking appliance 1. Here, the control and/or display panel 12 is positioned on the front of the exhaust hood 9. FIG. 8 again illustrates how a transmitter 13 is provided on the cooking appliance 1 for communicating with a virtual control panel 15.

### LIST OF REFERENCE NUMBERS

1 cooking appliance
2 base unit
3 wall
4 countertop
5 stove top
6 induction coil heating
7 hinge
8 exhaust vent
9 exhaust hood
10 mounting provisions
11 locking/unlocking elements
12 control and/or display panel
13 transmitter for virtual control panel
14 electrical system/electronics
15 virtual control panel
V vertical direction

1. A cooking appliance comprising a base unit (2) that is mounted on a wall (3) and/or on a countertop (4), and a stove top (5) that can be tilted relative to the base unit (2),
characterized in that
the stove top (5) contains at least one induction coil (6) for heating food to be cooked while the base unit (2) accommodates an electric power supply (14) for feeding to a minimum of one induction coil (6) a time-variable electric current of a high frequency.

2. Cooking appliance as in claim 1, characterized in that the stove top (5) only employs induction coils (6) for heating.

3. Cooking appliance as in claim 1, characterized in that the stove top (5) including the minimum of one induction coil (6) is of a flat plate-shaped design.

4. Cooking appliance as in claim 3, characterized in that the flat plate-shaped stove top (5) is essentially rectangular.

5. Cooking appliance as in claim 3, characterized in that the flat plate-shaped stove top (5) is essentially of a uniform thickness.

6. Cooking appliance as in claim 1, characterized in that a hinge (7) between the base unit (2) and the stove top (5) extends in a horizontal direction.

7. Cooking appliance as in claim 1, characterized in that it is additionally equipped with an integrated exhaust vent (8) or hood (9).

8. Cooking appliance as in claim 7, characterized in that the exhaust vent (8) is of a plate-shaped, rectangular basic contour.

9. Cooking appliance as in claim 7, characterized in that the exhaust vent (8) is connected with the base unit (2).

10. Cooking appliance as in claim 9, characterized in that the exhaust vent (8) extends in a vertical direction (V).

11. Cooking appliance as in claim 7, characterized in that the exhaust hood (9) is mounted above the base unit (2).

12. Cooking appliance as in claim 11, characterized in that the exhaust hood (9) is dome-shaped.

13. Cooking appliance as in claim 1, characterized in that the base unit (2) is equipped with mounting provisions (10) for attachment to a wall.

14. Cooking appliance as in claim 1, characterized in that elements are provided between the base unit (2) and the stove top (5) that serve to attenuate the relative angular movement between the two components.

15. Cooking appliance as in claim 1, further comprising locking and unlocking elements (11) by means of which the stove top (5) can be locked to and unlocked from the base unit (2).

16. Cooking appliance as in claim 6, characterized in that a control and/or display panel (12) is positioned on a far end of the stove top (5) relative to the hinge (7).

17. Cooking appliance as in claim 11, characterized in that a control and/or display panel (12) is positioned on the front of the exhaust hood (9).

18. Cooking appliance as in claim 1, characterized in that the stove top (5) is equipped with two induction coils (6).

19. Cooking appliance as in claim 18, characterized in that, when the stove top (5) is tilted up, the two induction coils (6) are vertically positioned one above the other.

20. Cooking appliance as in claim 1, characterized in that the stove top (5) is equipped with four induction coils (6).

21. Cooking appliance as in claim 1, further comprising a transmitter for a virtual control panel.
